(19) United States
(12) Patent Application Publication
(10) Pub. No.: US 2026/0349433 A1
(43) Pub. Date: Nov. 5, 2026

(54) FLIGHT CONTROL DEVICE, FLIGHT CONTROL METHOD, AND FLIGHT CONTROL PROGRAM

(71) Applicant: NEC Corporation, Tokyo (JP)

(72) Inventors: Eiichi TOKUMI, Tokyo (JP); Kenichi KIJIMA, Tokyo (JP); Tatsuya TANABIKI, Tokyo (JP); Takahiro MIZUTA, Tokyo (JP); Taichi SEISHI, Tokyo (JP); Takuya NOMURA, Tokyo (JP); Takumi KAMIYAMA, Tokyo (JP)

(73) Assignee: NEC Corporation, Tokyo (JP)

(21) Appl. No.: 19/487,492

(22) PCT Filed: May 2, 2024
(86) PCT No.: PCT/JP2024/016849

§ 371 Date: Nov. 25, 2025

(30) Foreign Application Priority Data
May 29, 2023 (JP) 2023-087846

(51) Int. Cl. G05D 1/617; G05D 1/227; G08G 5/70

(52) U.S. Cl. CPC G05D 1/617; G05D 1/227; G08G 5/70

(57) ABSTRACT

Provided are a flight control device, a flight control method, and a flight control program for ensuring the safety of the flight of a mobile body. The flight control device according to the present disclosure comprises: an authentication unit that, upon detection of a mobile body that has entered a predetermined area, authenticates the mobile body on the basis of an identification signal transmitted by the mobile body; a determination unit that calculates the flight risk of the authenticated mobile body and thereby determines the state of the mobile body; and an output unit that outputs position data obtained by measuring the position of the mobile body and state data indicating the state of the mobile body to a mobile control unit that controls the position of the authenticated mobile body.

### TECHNICAL FIELD

The present disclosure relates to a flight control device, a flight control method, and a flight control program.

### BACKGROUND ART

In recent years, development of a mobile body that moves in the air such as a drone is being advanced. In addition, in view of an increase in use of the mobile body, development of a system for appropriately controlling flight of a mobile body is being advanced. For example, PTL 1 discloses a technique of detecting a flying object based on position information and controlling landing of the flying object. PTL 2 discloses a technique of calculating a distance from an unmanned aerial vehicle to a drone port by analyzing a video photographed by the unmanned aerial vehicle, and controlling landing of the unmanned aerial vehicle. PTL 3 discloses a technique for authenticating a flying object.

### CITATION LIST

### Patent Literature

PTL 1: WO 2022/264696 A1

PTL 2: JP 2020-201832 A

PTL 3: JP 2017-037368 A

### SUMMARY OF INVENTION

When the mobile body is caused to fly out of the visual range of a pilot, for example, the information processing device controls the flight of the mobile body via the network. When the mobile body is caused to fly out of the visual range of the pilot, it is necessary to ensure the safety of the flight of the mobile body.

In view of the above problems, an object of the present disclosure is to provide a flight control device, a flight control method, and a flight control program that ensure the safety of the flight of a mobile body.

A flight control device according to the present disclosure includes,
an authentication unit for, upon detection of a mobile body that has entered a predetermined area, authenticating the mobile body based on an identification signal transmitted by the mobile body,
a determination unit for calculating a flight risk of the authenticated mobile body and determining a state of the mobile body, and
an output unit for outputting position data obtained by measuring a position of the mobile body and state data indicating the state of the mobile body to a mobile body control unit for controlling the position of the authenticated mobile body.

A flight control method according to the present disclosure in which a computer,
authenticates, upon detection of a mobile body that has entered a predetermined area, the mobile body based on an identification signal transmitted by the mobile body,
calculates a flight risk of the authenticated mobile body and determines a state of the mobile body, and
outputs position data obtained by measuring a position of the mobile body and state data indicating the state of the mobile body to a mobile body control unit for controlling the position of the authenticated mobile body.

A flight control program according to the present disclosure for causing a computer to execute,
processing of authenticating, upon detection of a mobile body that has entered a predetermined area, the mobile body based on an identification signal transmitted by the mobile body,
processing of calculating a flight risk of the authenticated mobile body and determining a state of the mobile body, and
processing of outputting position data obtained by measuring a position of the mobile body and state data indicating the state of the mobile body to a mobile body control unit for controlling the position of the authenticated mobile body.

According to the present disclosure, it is possible to provide a flight control device, a flight control method, and a flight control program that ensures the safety of the flight of the mobile body.

### BRIEF DESCRIPTION OF DRAWINGS

FIG. 1 is a block diagram illustrating a configuration of a flight control device according to the present disclosure.

FIG. 2 is a flowchart illustrating an example of a flow of a flight control method according to the present disclosure.

FIG. 3 is a block diagram illustrating a configuration of a flight control system according to the present disclosure.

FIG. 4 is a block diagram illustrating a configuration of a mobile body control device.

FIG. 5 is a block diagram illustrating a configuration of the flight control device according to the present disclosure.

FIG. 6 is a flowchart illustrating an operation of the flight control device according to the present disclosure.

FIG. 7 is a block diagram illustrating a configuration of the flight control device according to the present disclosure.

FIG. 8 is a flowchart illustrating an operation of the flight control device according to the present disclosure.

FIG. 9 is a block diagram illustrating a configuration of the flight control device according to the present disclosure.

FIG. 10 is a flowchart illustrating an operation of the flight control device according to the present disclosure.

Hereinafter, example embodiments of the present disclosure will be described in detail with reference to the drawings. In the drawings, the same or corresponding elements are denoted by the same reference numerals, and repeated description will be omitted as necessary for clarity of description.

### First Example Embodiment

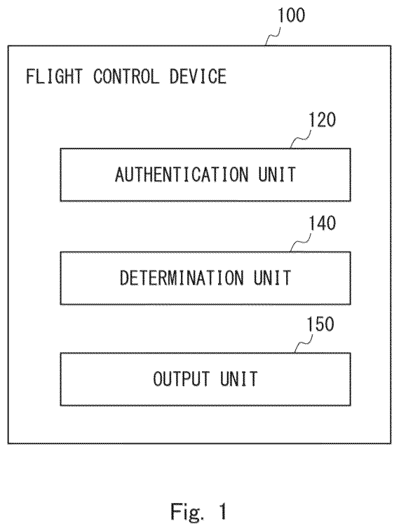

FIG. 1 is a block diagram illustrating a configuration of a flight control device 100 according to the present disclosure. The flight control device 100 includes an authentication unit 120, a determination unit 140, and an output unit 150.

When a mobile body (not illustrated) that has entered a predetermined area is detected, the authentication unit 120 authenticates the mobile body based on an identification number transmitted by the mobile body. The mobile body moves in the air by remote maneuvering. The mobile body is, for example, an unmanned aerial vehicle such as a drone. The identification number is a number for identifying the mobile body. After authenticating the mobile body based on the identification number, the authentication unit 120 may compare the authenticated identification number with a flight plan acquired in advance. The flight plan is information regarding a flight schedule of the mobile body. A flight plan 332 includes information such as an identification number of a mobile body, a scheduled flight time, and a scheduled flight route. The flight of the mobile body 10 is controlled, for example, by checking whether the mobile body 10 is passing through Way Point on time. Way Point is a ground facility installed on a predetermined route. When the mobile body is detected, the authentication unit 120 extracts an identification number of a mobile body scheduled to enter a predetermined area from the flight plan at the time upon detection of the entry. The authentication unit 120 verifies the identification number transmitted by the mobile body with the identification number extracted from the flight plan to authenticate the mobile body. For example, the authentication unit 120 authenticates whether the identification number transmitted by the mobile body is not an identification number that has been taken over but is an authorized identification number. A mobile body other than the mobile body flying according to the flight plan may enter the predetermined area. In a case where the identification number transmitted by the mobile body does not match the identification number extracted from the flight plan, the authentication unit 120 determines that the mobile body is a mobile body outside the flight plan.

The determination unit 140 calculates a flight risk of the mobile body authenticated by the authentication unit 120 and determines the state of the mobile body. For example, after the authentication unit 120 has performed verification of the actual flight status with the flight plan, the determination unit 140 determines the state of the mobile body based on the verification result. Furthermore, the determination unit 140 may determine the state of the mobile body by determining whether the mobile body included in the flight plan has passed through at the time/position according to the flight plan. The output unit 150 outputs the position data and the state data to a mobile body control unit for controlling the position of the mobile body authenticated by the authentication unit 120. The position data is data indicating a three-dimensional position of the mobile body. The position data is data obtained by measuring the position of the mobile body authenticated by the authentication unit 120. The position data is specified by, for example, videos photographed using at least two cameras. Furthermore, the model of the mobile body 10 may be specified based on the video photographed using one camera, and the position data may be estimated based on the size of the specified model and the number of pixels of the mobile body 10 in the video. The position data may be specified based on measurement data by a measuring instrument such as Light Detection And Ranging (LiDAR). The state data is data in which the determination unit 140 determines the state of the mobile body by the authentication unit 120.

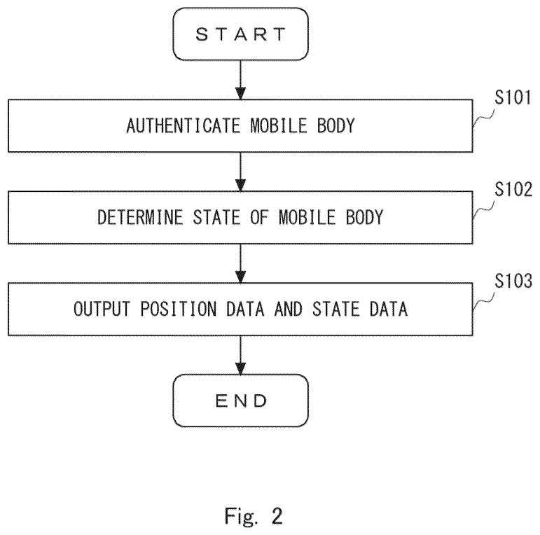

FIG. 2 is a flowchart illustrating a flow of a flight control method according to the present disclosure. When a mobile body that has entered the predetermined area is detected, the authentication unit 120 authenticates the mobile body based on an identification signal transmitted by the detected mobile body (step S101). The determination unit 140 calculates the flight risk of the mobile body authenticated in step S101 and determines the state of the mobile body (step S102). Next, the output unit 150 outputs the position data and the state data determined in step S104 to the mobile body control unit for controlling the position of the mobile body authenticated in step S101 (step S105).

As described above, in the flight control method according to the present disclosure, since the three-dimensional position of the mobile body that has entered the predetermined area is measured, the state of the mobile body can be more accurately monitored as compared with a case where the position is not measured. Therefore, in the flight control method according to the present disclosure, the safety of the flight of the mobile body can be ensured. The flowchart illustrated in FIG. 2 is an example and can be changed as appropriate.

The flight control device 100 includes a processor, a memory, and a storage device as components (not illustrated). In addition, the storage device stores a computer program in which processing of the flight control method according to the present disclosure is implemented. Then, the processor reads the computer program from the storage device into the memory and executes the computer program. As a result, the processor implements functions of a detection unit 110, the authentication unit 120, a measurement unit 130, the determination unit 140, and the output unit 150.

Alternatively, each constituent component of the flight control device 100 may be achieved by dedicated hardware. Some or all of the constituent components of each device may be implemented by general-purpose or dedicated circuitry, a processor, or a combination thereof. These constituent components may be configured by a single chip, or may be configured by a plurality of chips connected via a bus. Some or all of the constituent components of each device may be implemented by a combination of the above-described circuitry or the like and a program. As the processor, a Central Processing Unit (CPU), a Graphics Processing Unit (GPU), a Field-Programmable Gate Array (FPGA), a quantum processor (quantum computer control chip), or the like may be used.

When some or all of the constituent components of the flight control device 100 are implemented by a plurality of flight control devices, circuitries, or the like, the plurality of flight control devices, circuitries, or the like may be arranged in a centralized manner or in a distributed manner. For example, each of the flight control device, the circuitry, or the like may be achieved in the form of a client server system, a cloud computing system, or the like in which they are connected to each other through a communication network. Furthermore, the function of the flight control device 100 may be provided in a Software as a Service (SaaS) format.

### Second Example Embodiment

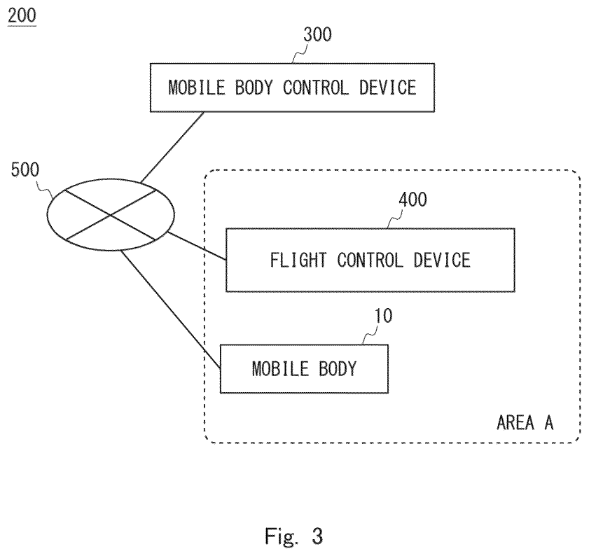

FIG. 3 is a block diagram illustrating a configuration of a flight control system 200 according to the present disclosure. FIG. 3 illustrates a mobile body 10 in addition to the flight control system 200. The flight control system 200 is an information system for controlling the flight of a mobile body such as a drone. The flight control system 200 includes a mobile body control device 300 and a flight control device 400. The mobile body control device 300 and the flight control device 400 are communicably connected via a network 500. Here, the network 500 is a wireless communication line.

The mobile body 10 is an unmanned aerial vehicle such as a drone, and is controlled by the mobile body control device 300. An area A is a predetermined area. The area A is, for example, an area where a port of the mobile body 10 is installed. The mobile body 10 moves in the air based on a predetermined flight plan. For example, the mobile body 10 takes off outside the area A and moves in the air based on a flight plan to land at a port provided in the area A.

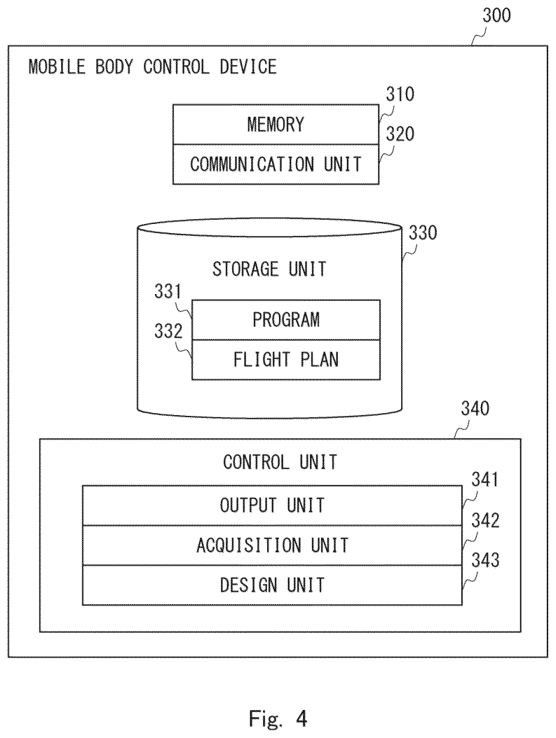

FIG. 4 is a block diagram illustrating a configuration of the mobile body control device 300. The mobile body control device 300 is an information processing device that controls the flight of the mobile body 10. That is, the mobile body control device 300 is an information processing device that controls the posture, position, and the like of the mobile body 10. The mobile body control device 300 may be installed anywhere as long as it can communicate with the mobile body 10. The mobile body control device 300 may be installed, for example, outside the area A. Furthermore, the mobile body control device 300 may be an information processing device mounted on the mobile body 10.

The mobile body control device 300 includes at least a memory 310, a communication unit 320, a storage unit 330, and a control unit 340, and may further include a display unit (not illustrated) and the like. The memory 310 is a storage area for temporarily storing processing content of the control unit 340, and is, for example, a volatile storage device such as a Random Access Memory (RAM). The communication unit 320 is an interface that performs communication with outside of the mobile body control device 300. The storage unit 330 is a storage device for storing the program 331, the flight plan 332, and the like. The program 431 is a computer program in which mobile body control processing and the like are implemented. The flight plan 332 is information regarding a flight schedule of the mobile body 10. The flight plan 332 includes information such as an identification number of the mobile body 10, a scheduled flight time, and a scheduled flight route. A display unit (not illustrated) is a user interface that presents various types of information to an administrator who controls the mobile body control device 300.

The control unit 340 includes at least an output unit 341 and an acquisition unit 342, and may further include a design unit 343 and the like. The control unit 340 is a control device that controls the operation of the mobile body control device 300. The control unit 340 is, for example, a processor such as a CPU. The control unit 340 reads the program 331 from the storage unit 330 into the memory 310 and executes the program. As a result, the control unit 440 achieves functions of the output unit 341, the acquisition unit 342, and the design unit 343.

The output unit 341 outputs a signal for controlling the mobile body 10 based on the flight plan 332 and the like stored in the storage unit 330. When receiving the position data and the state data of the mobile body 10 from the flight control device 400, the acquisition unit 342 acquires the position data and the state data. The design unit 343 designs a flight route based on the position data and the state data acquired by the acquisition unit 342 and the flight plan 332. When the design unit 343 designs the flight route, the output unit 341 outputs a signal for controlling the mobile body 10 based on the designed flight route. Since the flight route designed by the design unit 343 takes into consideration the position data and the state data of the mobile body 10, the mobile body 10 can be caused to fly more safely as compared with the flight route along the flight plan 332. That is, the mobile body control device 300 can ensure the safety of the flight of the mobile body 10 by causing the mobile body 10 to fly based on the flight route designed by the design unit 343.

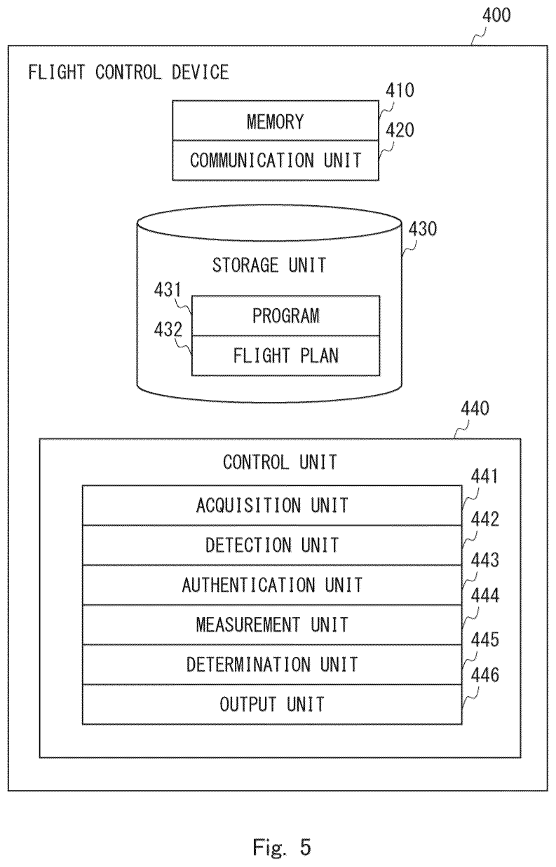

Next, a configuration of the flight control device 400 according to the present disclosure will be described with reference to FIG. 5. FIG. 5 is a block diagram illustrating a configuration of the flight control device 400 according to the present disclosure. The flight control device 400 is an example of the flight control device 100 described above. The flight control device 400 is an information processing device that estimates the position and determines the state of the mobile body 10 that has entered the area A, and outputs the position data and the state data to the mobile body control device 300. The flight control device 400 is installed at a place where communication with the mobile body 10 and the mobile body control device 300 is possible. The flight control device 400 is installed, for example, in the area A. The flight control device 400 is, for example, a server device achieved by a computer. The flight control device 400 may be made redundant by a plurality of servers. Each functional block of the flight control device 400 may be achieved by a plurality of computers. The flight control device 400 includes a memory 410, a communication unit 420, a storage unit 430, and a control unit 440.

The memory 410 is a storage area for temporarily storing processing content of the control unit 440, and is, for example, a volatile storage device such as a Random Access Memory (RAM). The communication unit 420 is an interface that communicates with the outside of the flight control device 400. The storage unit 430 is a storage device for storing the program 431, the flight plan 432, and the like. The program 431 is a computer program in which flight control processing according to the present disclosure is implemented. The flight plan 432 is information regarding a flight schedule of the mobile body 10.

The control unit 440 includes an acquisition unit 441, a detection unit 442, an authentication unit 443, a measurement unit 444, a determination unit 445, and an output unit 446. The control unit 440 is a control device that controls the operation of the flight control device 400. The control unit 440 is, for example, a processor such as a CPU. The control unit 440 reads a program 431 from the storage unit 430 into the memory 410 and executes the program. As a result, the control unit 440 achieves functions as the acquisition unit 441, the detection unit 442, the authentication unit 443, the measurement unit 444, the determination unit 445, and the output unit 446.

The mobile body control device 300 creates a flight plan in advance before the flight of the mobile body 10, and submits the flight plan to the flight control device 400. The flight control device 400 stores the submitted flight plan 432 in the storage unit 430. Here, the flight plan 432 includes an identification number for identifying the mobile body 10 caused to fly based on the flight plan. The flight control device 400 can grasp the identification number of the mobile body scheduled to enter the area A at a predetermined time by acquiring the flight plan in advance.

The detection unit 442 detects the mobile body 10 that has entered the area A. For example, the detection unit 442 may detect the mobile body 10 that has entered the area A by analyzing a video photographed by a camera (not illustrated) installed in the area A. In addition, the flight control device 400 may include a camera for photographing the inside of the area A as a hardware configuration. The detection unit 442 may detect the mobile body 10 that has entered the area A by analyzing a video photographed by a camera included in the flight control device 400. Here, it is assumed that the mobile body 10 is mounted with a remote ID device that transmits its own remote ID, that is, an identification number. The detection unit 442 may detect the mobile body 10 by detecting an identification number transmitted from the remote ID device mounted on the mobile body 10.

The authentication unit 443 authenticates the mobile body based on the identification number transmitted by the mobile body. Specifically, the authentication unit 443 authenticates the mobile body 10 by verifying an identification number transmitted from a remote ID device mounted on the mobile body 10 with an identification number included in the flight plan 432.

The measurement unit 444 measures the position of the mobile body 10 authenticated by the authentication unit 443. For example, the measurement unit 444 may measure the position of the mobile body 10 by analyzing a video photographed by a camera (not illustrated) installed in the area A. Furthermore, the measurement unit 444 may measure the position of the mobile body 10 by analyzing a video photographed by a camera included in the flight control device 400. Furthermore, the measurement unit 444 may measure the position of the mobile body 10 based on measurement data by a measuring instrument such as Light Detection And Ranging (LiDAR) installed in the area A. Furthermore, the measurement unit 444 may acquire position data measured based on measurement data such as a camera or LiDAR installed outside the flight control device 400.

The determination unit 445 calculates a flight risk of the mobile body 10 authenticated by the authentication unit 443 and determines the state of the mobile body 10. Furthermore, the determination unit 445 may acquire the state of the mobile body 10 determined by the camera and the measuring instrument such as LiDAR. The flight risk is a numerical value obtained by quantitatively calculating the possibility that the mobile body 10 will be in a dangerous state at the time of flight, landing, or the like. The mobile body 10 performs position control by, for example, repeatedly performing (looping) grasping of own position information and correction of inclination, speed, direction, and the like based on the grasped position information. By performing such a position control loop, the mobile body 10 can correct its own position and return to the scheduled flight route even if the mobile body 10 slightly deviates from the scheduled flight route. Therefore, the determination unit 445 calculates the flight risk of the mobile body 10 in consideration of the error correctable by the control loop. For example, the determination unit 445 calculates the flight risk to be high in the case where the mobile body 10 is deviated from the scheduled flight route by more than the error correctable by the control loop.

For example, the determination unit 445 calculates the flight risk of the mobile body 10 based on the flight information of the mobile body 10. The flight information is information regarding the mobile body 10 at the time of flight. The flight information may be information determined by the mobile body 10 itself or information regarding the mobile body 10 measured from the outside. The information determined by the mobile body 10 itself is, for example, the motor rotation speed of the mobile body 10. The information regarding the mobile body 10 measured from the outside is, for example, the behavior of the mobile body 10 at the time of flight, the position of the mobile body 10, the communication state of the mobile body 10, and the like. The flight information may include a temporal change in information regarding the mobile body 10. The flight information may include, for example, a temporal change in the position of the mobile body 10, that is, a trajectory of the mobile body 10. The determination unit 445 may acquire the flight information transmitted by the mobile body 10. The determination unit 445 may acquire the flight information of the mobile body 10 by analyzing a video photographed by a camera or measurement data by a measuring instrument such as LiDAR. In a case where the flight risk of the mobile body 10 is equal to or greater than a predetermined value, the determination unit 445 determines that the mobile body 10 is in a dangerous state.

The output unit 446 outputs the position data measured by the measurement unit 444 and the state data determined by the determination unit 445 to the mobile body control device 300.

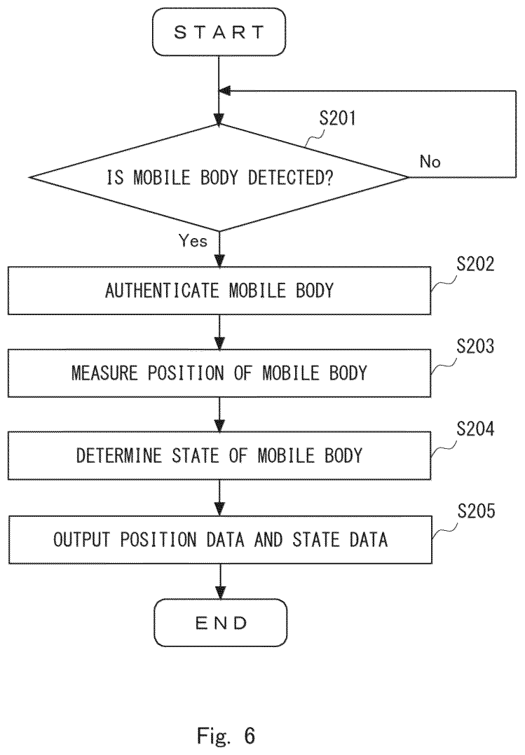

Next, an example of a flow of flight control processing according to the present disclosure will be described with reference to FIG. 6. FIG. 6 is a flowchart illustrating an operation of the flight control device 400 according to the present disclosure. It is assumed that the flight control device 400 acquires the flight plan of the mobile body 10 before performing the flight control processing. First, the detection unit 442 detects the mobile body 10 entering the area A (step S201). When the detection unit 442 detects the mobile body 10 (step S201 Yes), the authentication unit 443 authenticates the mobile body 10 detected in step S201 (step S202). Next, the measurement unit 444 measures the position of the mobile body 10 detected in step S201 (step S203). Then, the determination unit 445 calculates the flight risk of the mobile body 10 detected in step 201 and determines the state of the mobile body 10 (Step S204). Next, the output unit 446 outputs the position data measured in step S203 and the state data determined in step S204 to the mobile body control device 300 (step 205).

As described above, in the flight control method according to the present disclosure, measurement of the position and determination of the state are performed for the mobile body 10 that has entered the area A, and the position data and the state data are output to the mobile body control device 300 for controlling the mobile body 10. Therefore, the mobile body control device 300 can design a flight route based on the position data and the state data and more safely control the mobile body 10. As described above, the flight control method according to the present disclosure can ensure the safety of the flight of the mobile body.

### Third Example Embodiment

A third example embodiment is a modified example of the second example embodiment described above. In the second example embodiment, the position data and the state data of the mobile body 10 are output to the mobile body control device 300. On the other hand, in the third example embodiment, the flight route is output to the mobile body control device 300. Hereinafter, description of a flight control device 600 according to the present disclosure repeated from the second example embodiment and the like will be appropriately omitted.

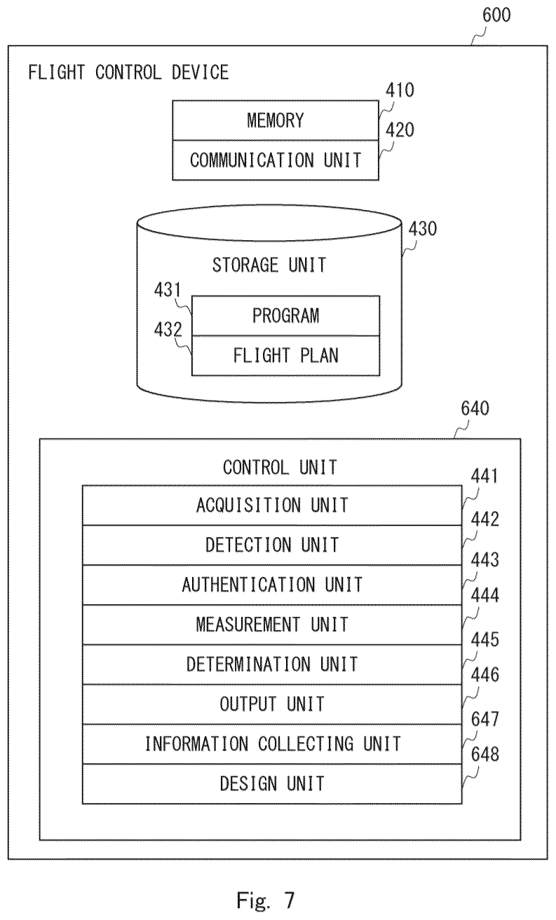

FIG. 7 is a block diagram illustrating a configuration of the flight control device 600 according to the present disclosure. As illustrated in FIG. 7, the flight control device 600 is different from the flight control device 400 illustrated in FIG. 3 in that a control unit 640 is included instead of the control unit 440. The control unit 640 includes an information collecting unit 647 and a design unit 648 in addition to the configuration included in the control unit 440.

The information collecting unit 647 collects peripheral information around the mobile body 10. Specifically, the information collecting unit 647 collects peripheral information in the vicinity of the mobile body 10 that is flying, in the vicinity of a port installed in the area A, and the like. The peripheral information is, for example, a weather condition around the mobile body 10, an abnormality of a port installed in the area A, and the like. The abnormality of the port installed in the area A is, for example, an unexpected flying object, a stopping of another mobile body, or the like. For example, the information collecting unit 647 may collect peripheral information around the mobile body 10 by analyzing a video photographed by a camera (not illustrated) installed in the area A. Furthermore, the information collecting unit 647 may collect peripheral information around the mobile body 10 by analyzing a video photographed by a camera included in the flight control device 400. In addition, the information collecting unit 647 may collect peripheral information around the mobile body 10 based on measurement data by a measuring instrument such as an anemometer installed in the area A. The information collecting unit 647 may collect peripheral information around the mobile body 10 by acquiring a weather forecast or the like announced most recently. In the third example embodiment, the determination unit 445 calculates the flight risk of the mobile body 10 in consideration of the peripheral information collected by the information collecting unit 647.

The design unit 648 designs a flight route for the mobile body 10 to avoid danger based on the state of the mobile body 10 determined by the determination unit 445. Specifically, the design unit 648 estimates a danger that may occur in the case where the mobile body 10 continues the flight according to the flight plan, based on the state of the mobile body 10 determined by the determination unit 445. Then, the design unit 648 designs the flight route of the mobile body 10 in such a way as to avoid the estimated danger. For example, in the case where the information collecting unit 647 collects information on the wind speed in the vicinity of the port installed in the area A, the determination unit 445 calculates the flight risk of the mobile body 10 in consideration of the wind speed. Then, in a case where the flight risk is equal to or greater than a predetermined value, the design unit 648 designs a flight route for waiting in the air until the wind speed becomes less than the predetermined value. In the third example embodiment, the output unit 446 outputs the flight route designed by the design unit 648 to the mobile body control device 300. Upon receiving the flight route, the mobile body control device 300 controls the mobile body 10 based on the flight route.

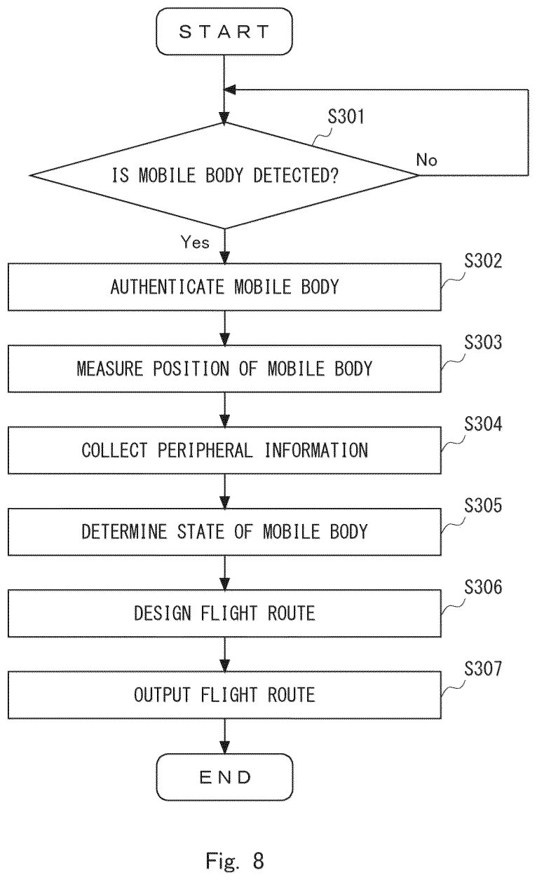

Next, an example of a flow of flight control processing according to the present disclosure will be described with reference to FIG. 8. FIG. 8 is a flowchart illustrating an operation of the flight control device 600 according to the present disclosure. It is assumed that the flight control device 600 acquires the flight plan of the mobile body 10 before performing the flight control processing. First, the detection unit 442 detects the mobile body 10 entering the area A (step S301). When the detection unit 442 detects the mobile body 10 (step S301 Yes), the authentication unit 443 authenticates the mobile body 10 detected in step S301 (step S302). Next, the measurement unit 444 measures the position of the mobile body 10 detected in step S301 (step S303). Next, the information collecting unit 647 collects the peripheral information around the mobile body 10 (step S304). Then, the determination unit 445 calculates the flight risk of the mobile body 10 detected in step 301 and determines the state of the mobile body 10 (step S305). Next, the design unit 648 designs a flight route based on the state of the mobile body 10 determined by the determination unit 445 (step S306). Next, the output unit 446 outputs the flight route designed in step S306 to the mobile body control device 300 (step 307).

As described above, the flight control method according to the present disclosure includes performing measurement of the position and determination of the state of the mobile body 10 that has entered the area A, and outputting the flight route to the mobile body control device 300 for controlling the mobile body 10. Therefore, the mobile body control device 300 can more safely control the mobile body 10 based on the designed flight route. As described above, the flight control method according to the present disclosure can ensure the safety of the flight of the mobile body.

### Fourth Example Embodiment

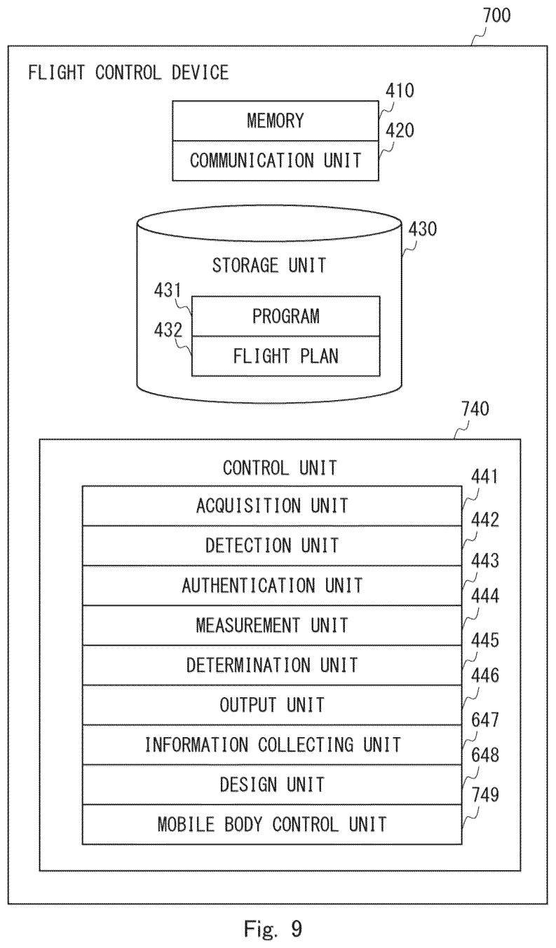

A fourth example embodiment is a modified example of the third example embodiment described above. In the fourth example embodiment, the flight control device controls the mobile body based on the designed flight route. FIG. 9 is a block diagram illustrating a configuration of a flight control device 700 according to the present disclosure. The flight control device 700 is different from the flight control device 600 illustrated in FIG. 7 in that a control unit 740 is included instead of the control unit 640. The control unit 740 includes a mobile body control unit 749 in addition to the configuration included in the control unit 640.

The mobile body control unit 749 receives the control right of the mobile body 10 from the mobile body control device 300 and controls the mobile body 10. For example, in the case where the determination unit 445 determines that the mobile body 10 is in a dangerous state, the mobile body control unit 749 transmits a control right request to the mobile body control device 300. The mobile body control device 300 displays the reception of the control right request on a display unit (not illustrated). When confirming that the control right request has been received, the administrator of the mobile body control device 300 instructs the mobile body control device 300 to transfer the control right to the flight control device 700. The mobile body control device 300 transfers the control right of the mobile body 10 to the flight control device 700 according to an instruction of the administrator. Upon receiving the control right of the mobile body 10, the mobile body control unit 749 controls the mobile body 10 based on the flight route designed by the design unit 648.

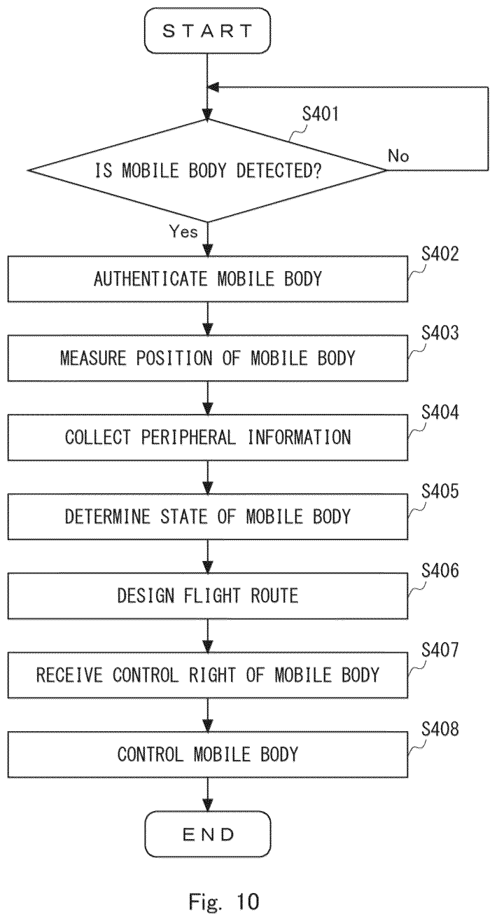

Next, an example of a flow of flight control processing according to the present disclosure will be described with reference to FIG. 10. FIG. 10 is a flowchart illustrating an operation of the flight control device 700 according to the present disclosure. It is assumed that the flight control device 700 acquires the flight plan of the mobile body 10 before performing the flight control processing. Since each step of steps S401 to S406 is similar to each step of steps S301 to S306 described in FIG. 8, the description thereof will be omitted. The mobile body control unit 749 receives the control right of the mobile body 10 from the mobile body control device 300 (step S407). Next, the mobile body control unit 749 controls the mobile body 10 based on the flight route designed in step S406 (step S408).

As described above, the flight control method according to the present disclosure performs measurement of the position and determination of the state for the mobile body 10 that has entered the area A, and receives the control right of the mobile body 10 from the mobile body control device 300. Therefore, the flight control device 700 can control the mobile body 10 based on the designed flight route. As described above, the flight control method according to the present disclosure can ensure the safety of the flight of the mobile body.

In the example illustrated in FIG. 10, after the design unit 648 designs the flight route (step S406), the mobile body control unit 749 receives the control right of the mobile body 10 (step S407). However, the timing of receiving the control right is not particularly limited. For example, the mobile body control unit 749 may receive the control right of the mobile body 10 after the mobile body 10 is authenticated (step S402). In this case, the mobile body control unit 749 performs control such as causing the mobile body 10 to land at a port installed in the area A based on the flight plan 432 stored in the storage unit 430. Furthermore, in this case as well, similarly to the case illustrated in FIG. 10, once the flight route is designed, the mobile body control unit 749 controls the mobile body 10 based on the flight route.

Furthermore, after receiving the control right of the mobile body 10, the mobile body control unit 749 may appropriately transmit the position data of the mobile body to the mobile body control device 300. The administrator of the mobile body control device 300 may be able to view the transmitted position data from the display unit of the mobile body control device 300. In addition, in the case where the mobile body 10 lands at a port installed in the area A, the mobile body control unit 749 may notify at least one of the administrator of the flight control device 700 and the administrator of the mobile body control device 300 that the mobile body 10 has landed.

### Other Example Embodiment

Note that, in the above-described example embodiments, the configuration of the hardware has been described, but the present disclosure is not limited thereto. According to the present disclosure, any processing can also be achieved by causing a CPU to execute a computer program.

In the above-described example, the program includes a command group (or software code) for causing the computer to perform one or more functions described in the example embodiment upon being read by the computer. The program may be stored in a non-transitory computer-readable medium or a tangible storage medium. By way of example, and not limitation, computer-readable medium or tangible storage medium includes a random-access memory (RAM), a read-only memory (ROM), a flash memory, a solid-state drive (SSD) or other memory technology, CD-ROM, a digital versatile disc (DVD), Blu-ray (registered trademark) disc or other optical disk storage, a magnetic cassette, a magnetic tape, a magnetic disk storage, or other magnetic storage devices. The program may be transmitted on a transitory computer-readable medium or communication medium. By way of example, and not limitation, transitory computer-readable medium or communication medium includes electrical, optical, acoustic, or other forms of propagated signals.

The present disclosure is not limited to the example embodiments described above, and may be appropriately changed without departing from the scope. Furthermore, the present disclosure may be implemented by appropriately combining the example embodiments.

Some or all of the above-described example embodiments may also be described as the following supplementary notes, but are not limited to the following supplementary notes.

### (Supplementary Note A1)

A flight control device including,
an authentication unit for, upon detection of a mobile body that has entered a predetermined area, authenticating the mobile body based on an identification signal transmitted by the mobile body,
a determination unit for calculating a flight risk of the authenticated mobile body and determining a state of the mobile body, and
an output unit for outputting position data obtained by measuring a position of the mobile body and state data indicating the state of the mobile body to a mobile body control unit for controlling the position of the authenticated mobile body.

### (Supplementary Note A2)

The flight control device according to supplementary note A1, in which the determination unit calculates a flight risk of the mobile body based on flight information of the mobile body.

### (Supplementary Note A3)

The flight control device according to supplementary note A1, further including an information collecting unit for collecting peripheral information around the mobile body,
in which the determination unit calculates a flight risk of the mobile body in consideration of the peripheral information.

### (Supplementary Note A4)

The flight control device according to supplementary note A1, further including a design unit for designing a flight route for the mobile body to avoid danger based on the state of the mobile body,
in which the output unit outputs the flight route to the mobile body control unit.

### (Supplementary Note A5)

The flight control device according to supplementary note A4, in which the design unit estimates a danger that may occur if the mobile body continues flight based on the state data, and designs the flight route in such a way as to avoid the danger.

### (Supplementary Note A6)

The flight control device according to supplementary note A4, further including a mobile body control unit for controlling the mobile body based on the output flight route.

### (Supplementary Note A7)

The flight control device according to supplementary note A1, in which the detection unit detects the mobile body by receiving an identification signal transmitted from the mobile body.

### (Supplementary Note A8)

The flight control device according to supplementary note A1, in which the position data is data indicating a three-dimensional position of the mobile body.

### (Supplementary Note A9)

The flight control device according to supplementary note A6, further including an acquisition unit for acquiring a flight plan of the mobile body,
in which the mobile body control unit controls the mobile body based on the flight plan.

### (Supplementary Note A10)

The flight control device according to supplementary note A6, in which the mobile body control unit performs control for the mobile body to land in a predetermined area.

### (Supplementary Note A11)

The flight control device according to supplementary note A6, in which the mobile body control unit receives a control right for controlling the mobile body from an administrator of the mobile body.

### (Supplementary Note A12)

The flight control device according to supplementary note A6, in which the mobile body control unit provides position data of the mobile body to an administrator of the mobile body in a viewable manner.

### (Supplementary Note A13)

The flight control device according to supplementary note A6, in which upon the mobile body having landed, the mobile body control unit notifies an administrator of the flight control device of the landing of the mobile body.

### (Supplementary Note B1)

A flight control system including,
a flight control device, and
a mobile body control device for controlling a mobile body, the mobile body control device communicable with the flight control device, in which
the flight control device,
authenticates, upon detection of the mobile body that has entered a predetermined area, the mobile body based on an identification signal transmitted by the mobile body,
calculates a flight risk of the authenticated mobile body and determines a state of the mobile body, and
outputs position data obtained by measuring a position of the mobile body and state data indicating the state of the mobile body to the mobile body control device for controlling the position of the authenticated mobile body.

### (Supplementary Note C1)

A flight control method in which a computer,
authenticates, upon detection of a mobile body that has entered a predetermined area, the mobile body based on an identification signal transmitted by the mobile body,
calculates a flight risk of the authenticated mobile body and determines a state of the mobile body, and
outputs position data obtained by measuring a position of the mobile body and state data indicating the state of the mobile body to a mobile body control unit for controlling the position of the authenticated mobile body.

### (Supplementary Note D1)

A flight control program for causing a computer to execute,
processing of authenticating, upon detection of a mobile body that has entered a predetermined area, the mobile body based on an identification signal transmitted by the mobile body,
processing of calculating a flight risk of the authenticated mobile body and determining a state of the mobile body, and
processing of outputting position data obtained by measuring a position of the mobile body and state data indicating the state of the mobile body to a mobile body control unit for controlling the position of the authenticated mobile body.

Some or all of the elements (e.g., configurations and functions) described in Supplementary Notes A2 to A13 dependent on Supplementary Note A1 can also be dependent on Supplementary Notes B1 to D1 by a similar dependency relationship as Supplementary Notes A2 to A13. Some or all of the elements described in any Supplementary Note may be applied to various types of hardware, software, recording means for recording software, systems, and methods.

While the disclosure of the present application has been particularly shown and described with reference to example embodiments thereof, the disclosure of the present application is not limited to the above. It will be understood by those of ordinary skill in the art that various changes in form and details may be made therein without departing from the spirit and scope of the disclosure of the present application as defined by the claims.

This application is based upon and claims the benefit of priority from Japanese patent application No. 2023-087846, filed on May 29, 2023, the disclosure of which is incorporated herein in its entirety by reference.

### REFERENCE SIGNS LIST

10 mobile body
100 flight control device
110 detection unit
120 authentication unit
130 measurement unit
140 determination unit
150 output unit
200 flight control system
300 mobile body control device
310 memory
330 storage unit
331 program
332 flight plan
340 control unit
341 output unit
342 acquisition unit
343 design unit
400 flight control device
410 memory
420 communication unit
430 storage unit
431 program
432 flight plan
440 control unit
441 acquisition unit
442 detection unit
443 authentication unit
444 measurement unit
445 determination unit
446 output unit
500 network
600 flight control device
640 control unit
647 information collecting unit
648 design unit
700 flight control device
740 control unit
749 mobile body control unit

What is claimed is:

1. A flight control device comprising:
at least one memory that is configured to instructions; and
at least one processor that is configured to execute the instructions to:
upon detection of a mobile body that has entered a predetermined area, authenticate the mobile body based on an identification signal transmitted by the mobile body;
calculate a flight risk of the authenticated mobile body and determining a state of the mobile body; and
output position data obtained by measuring a position of the mobile body and state data indicating the state of the mobile body.

2. The flight control device according to claim 1, wherein the at least one processor is configured to execute the instructions to calculate a flight risk of the mobile body based on flight information of the mobile body.

3. The flight control device according to claim 1, the at least one processor is configured to execute the instructions to collect peripheral information around the mobile body; and
calculate a flight risk of the mobile body in consideration of the peripheral information.

4. The flight control device according to claim 1, the at least one processor is configured to execute the instructions to design a flight route for the mobile body to avoid danger based on the state of the mobile body; and
output the flight route.

5. The flight control device according to claim 4, wherein the at least one processor is configured to execute the instructions to estimate danger that may occur if the mobile body continues flight based on the state data, and designs the flight route in such a way as to avoid the danger.

6. The flight control device according to claim 4, the at least one processor is configured to execute the instructions to control the mobile body based on the output flight route.

7. The flight control device according to claim 1, the at least one processor is configured to execute the instructions to detect the mobile body by receiving an identification signal transmitted from the mobile body.

8. The flight control device according to claim 1, wherein the position data is data indicating a three-dimensional position of the mobile body.

9. The flight control device according to claim 6, the at least one processor is configured to execute the instructions to acquire a flight plan of the mobile body; and
control the mobile body based on the flight plan.

10. The flight control device according to claim 6, wherein the at least one processor is configured to execute the instructions to perform control for the mobile body to land in a predetermined area.

11. The flight control device according to claim 6, wherein the at least one processor is configured to execute the instructions to receives a control right for controlling the mobile body from an administrator of the mobile body.

12. The flight control device according to claim 6, wherein the at least one processor is configured to execute the instructions to provide position data of the mobile body to an administrator of the mobile body in a viewable manner.

13. The flight control device according to claim 6, wherein upon the mobile body having landed, the at least one processor is configured to execute the instructions to notify an administrator of the flight control device of the landing of the mobile body.

14.-16. (canceled)

17. A flight control method in which a computer,
authenticates, upon detection of a mobile body that has entered a predetermined area, the mobile body based on an identification signal transmitted by the mobile body,
calculates a flight risk of the authenticated mobile body and determines a state of the mobile body, and
outputs position data obtained by measuring a position of the mobile body and state data indicating the state of the mobile body to a mobile body control unit for controlling the position of the authenticated mobile body.

18. The flight control method according to claim 17, wherein the computer calculates a flight risk of the mobile body based on flight information of the mobile body.

19. A non-transitory computer readable medium storing a flight control program for causing a computer to execute:
processing of authenticating, upon detection of a mobile body that has entered a predetermined area, the mobile body based on an identification signal transmitted by the mobile body;
processing of calculating a flight risk of the authenticated mobile body and determining a state of the mobile body; and
processing of outputting position data obtained by measuring a position of the mobile body and state data indicating the state of the mobile body to a mobile body control unit for controlling the position of the authenticated mobile body.

20. The non-transitory computer readable medium storing the flight control program according to claim 19, further causing the computer to execute processing of calculating a flight risk of the mobile body based on flight information of the mobile body.
